(19) United States
(12) Patent Application Publication
(10) Pub. No.: US 2022/0279015 A1
(43) Pub. Date: Sep. 1, 2022

(54) METHOD FOR DETECTING FINANCIAL ATTACKS IN EMAILS

(71) Applicant: Armorblox, Inc., Cupertino, CA (US)

(72) Inventors: Arjun Sambamoorthy, Cupertino, CA (US); Prashanth Arun, Cupertino, CA (US); Holly Pike, Cupertino, CA (US); Chris Wang, Cupertino, CA (US); DJ Sampath, Cupertino, CA (US)

(21) Appl. No.: 17/683,221

(22) Filed: Feb. 28, 2022

Related U.S. Application Data
(60) Provisional application No. 63/154,644, filed on Feb. 26, 2021.

(51) Int. Cl. H04L 9/40; G06F 40/20; G06F 40/103; H04L 51/00

(52) U.S. Cl. CPC H04L 63/1483; G06F 40/20; G06F 40/103; H04L 51/14

(57) ABSTRACT

A method for detecting financial attacks in emails includes: accessing an email inbound to a recipient address; scanning a body of the email for language signals; correlating a first sequence of words, in the email, with a financial signal; correlating a second sequence of words, in the email, with an action request signal; calculating a risk for the email representing a financial attack based on the financial signal and the action request signal detected in the email; and, in response to the risk exceeding a threshold risk, annotating the first sequence of words in the email according to a first visual highlighting scheme associated with the financial signal, annotating the second sequence of words in the email according to a second visual highlighting scheme—different from the first visual highlighting scheme—associated with the action request signal, and redirecting the email to a quarantine folder.

### CROSS-REFERENCE TO RELATED APPLICATIONS

This Application claims the benefit of U.S. Provisional Application No. 63/154,644, filed on 26 Feb. 2021, which is incorporated in its entirety by this reference.

### TECHNICAL FIELD

This invention relates generally to the field of Internet security and more specifically to a new and useful method for detecting financial attacks in emails in the field of Internet security.

### BRIEF DESCRIPTION OF THE FIGURES

FIGS. 1A and 1B are a flowchart representation of a method;

FIGS. 2A-2C are a flowchart representation of one variation of the method;

FIGS. 3A and 3B are a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

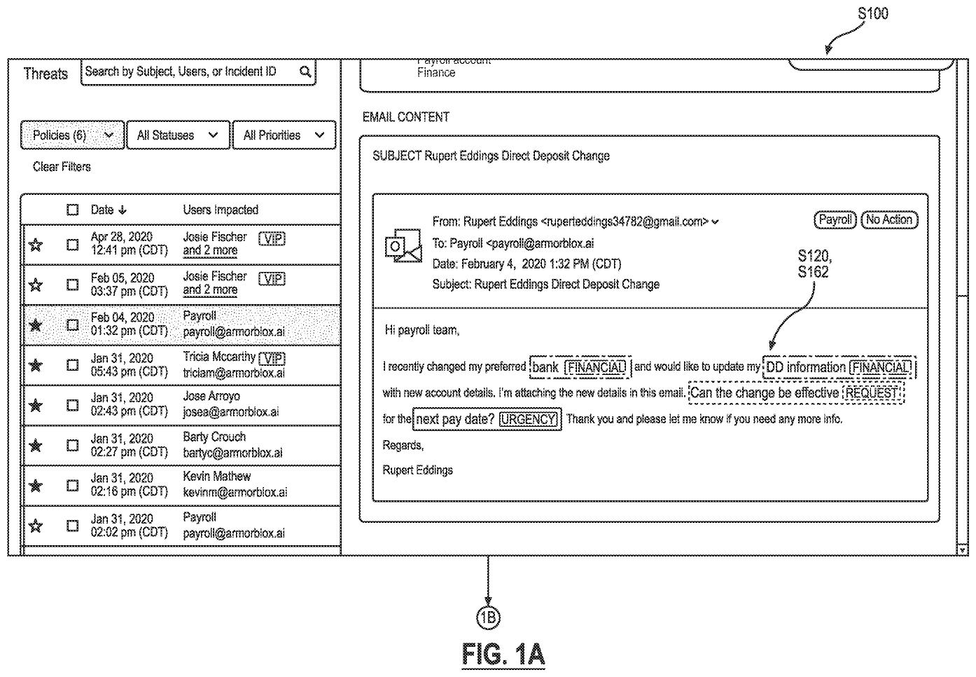

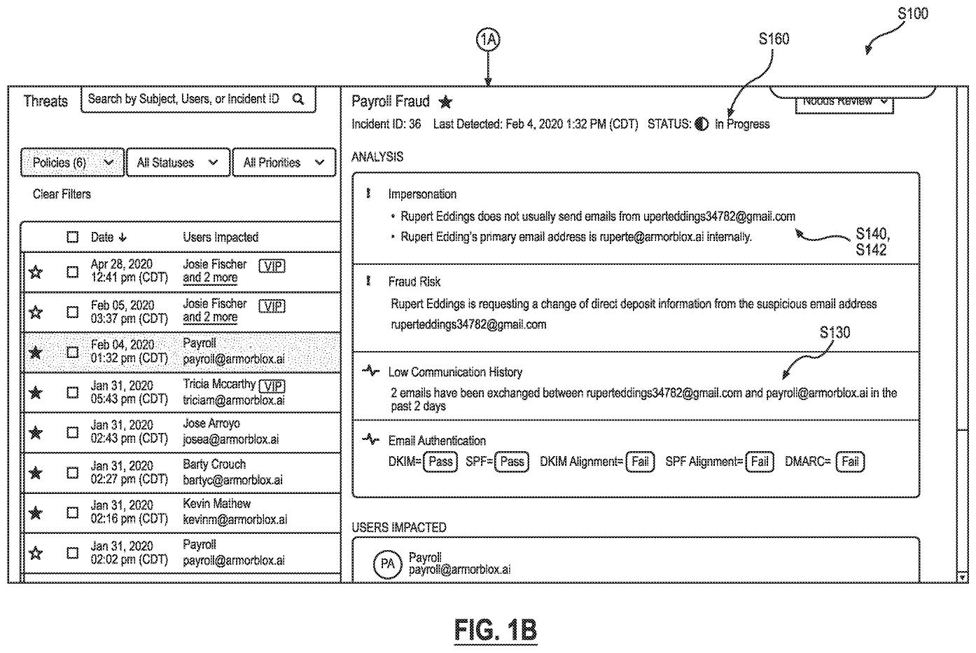

As shown in FIGS. 1A, 1B, 2A, 2B, 2C, 3A, and 3B, a method S100 for detecting financial attacks in emails includes: accessing an email in Block S110; scanning the email for a set of language signals in Block S120, including a financial signal including a first set of words containing financial concepts, an action signal including a second set of words prompting an action and an urgency signal including a third set of words implying necessity of the action; deriving a communication frequency signal based on a frequency of past communications between a sender address of the email and a recipient address of the email in Block S130; retrieving a verified email address including a display name analogous to a sender display name of the sender address in Block S140; deriving an impersonation signal based on a difference between the verified email address and the sender address in Block S142; calculating a risk for the email representing a financial attack based on a combination of the set of language signals, the communication frequency signal, and the impersonation signal in Block S150; in response to the risk exceeding a threshold, enacting a remediation for the email (e.g., quarantining, deleting, mark as unsafe, locking out user access to the email, blacklisting the email sender) prior to delivery of the email to the recipient address in Block S160; and presenting the email to a security analyst in Block S162 with the first set of words in the email highlighted with a finance label, the second set of words in the email highlighted with an action label, and the third set of words in the email highlighted with an urgency label.

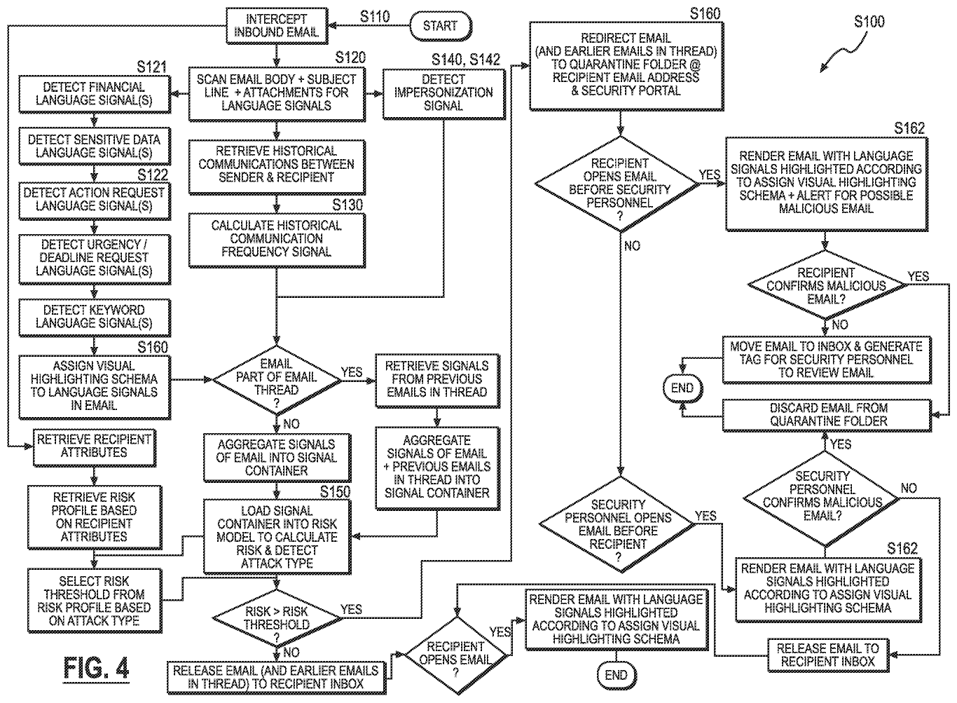

One variation of the method S100 shown in FIG. 4 includes: accessing an email inbound to a recipient address in Block S110; scanning a body of the email for a set of language signals in Block S120; correlating a first sequence of words, in the email, with a financial signal in the set of language signals in Block S121; correlating a second sequence of words, in the email, with an action request signal in the set of language signals in Block S122; and calculating a risk for the email representing a financial attack based on a combination of the financial signal and the action request signal detected in the email in Block S150. This variation of the method S100 also includes, in response to the risk exceeding a threshold risk: annotating the first sequence of words in the email according to a first visual highlighting scheme associated with the financial signal in Block S160; annotating the second sequence of words in the email according to a second visual highlighting scheme associated with the action request signal in Block S160, the second visual highlighting scheme different from the first visual highlighting scheme; and redirecting the email to a quarantine folder in Block S160.

Another variation of the method S100 shown in FIG. 4 includes: intercepting an email inbound to a recipient address in Block S110; scanning a body of the email for a set of language signals in Block S120; correlating a first sequence of words, in the email, with a first signal in the set of language signals in Block S121; correlating a second sequence of words, in the email, with a second signal in the set of language signals in Block S122; and calculating a risk for the email representing a financial attack based on a combination of the first signal and the second signal detected in the email in Block S150. This variation of the method S100 also includes, in response to the risk exceeding a threshold risk: annotating the first sequence of words in the email according to a first visual highlighting scheme associated with the financial signal in Block S160; annotating the second sequence of words in the email according to a second visual highlighting scheme associated with the action request signal in Block S160, the second visual highlighting scheme different from the first visual highlighting scheme; and redirecting the email away from an email inbox associated with the recipient address in Block S160. This variation of the method S100 further includes, in response to selection of the email within an email viewer, rendering the email with the first sequence of words highlighted according to the first visual highlighting scheme and with the second sequence of words highlighted according to the second visual highlighting scheme in Block S162.

Another variation of the method S100 shown in FIG. 4 includes: intercepting an email inbound to a recipient address in Block S110; scanning a body of the email for a set of language signals in Block S120; correlating a first sequence of words, in the email, with a financial signal in the set of language signals in Block S121; correlating a second sequence of words, in the email, with an action request signal in the set of language signals in Block S122; correlating a third sequence of words, in the email, with an urgency signal in the set of language signals; and calculating a risk for the email representing a financial attack based on a combination of the financial signal, the action request signal, and the urgency signal detected in the email in Block S150. This variation of the method S100 also includes, in response to the risk exceeding a threshold risk: annotating the first sequence of words in the email according to a first visual highlighting scheme associated with the financial signal in Block S160; annotating the second sequence of words in the email according to a second visual highlighting scheme associated with the action request signal in Block S160, the second visual highlighting scheme different from the first visual highlighting scheme; annotating the third sequence of words in the email according to a third visual highlighting scheme associated with the urgency signal in Block S160, the third visual highlighting scheme different from the first visual highlighting scheme and the second visual highlighting scheme; and redirecting the email away from an email inbox associated with the recipient address in Block S160.

### 2. Applications

Generally, Blocks of the method S100 can be executed by a computer system (e.g., an incoming mail server, a security server, a computer network): to intercept an email inbound to an organization (e.g., a computer network or email domain operated by the organization); to extract an array of language, temporal, and security signals representing critical concepts contained in the body email, indicators of compromise in email metadata, and historical communications between the sender and recipient of the email; to fuse these signals into a prediction of a risk that the email represents a security threat to the recipient or organization more generally; to remediate (e.g., quarantine) the email if this risk exceeds a threshold; and to repackage the email into a report or user interface that highlights critical language, temporal, and/or security signals detected in the email, thereby enabling security personnel to quickly and accurately review the email and either elect to release the email or reinforce interpretation of these signals as malicious.

Therefore, the computer system can execute the method S100: to detect malicious inbound emails; to remediate these emails for review by security personnel; and to selectively highlight language signals that indicate malicious intent and surface temporal and security signals that reinforce identification of the email as malicious, thereby enabling security personnel to rapidly and accurately review the email and update models for detecting language, temporal, and security signals based on whether the security personnel confirms the email as malicious.

For example, the computer system can execute the method S100 to detect and remediate by quarantine: zero-day credential phishing attacks via email; attempted payroll fraud via email action requests; and social engineering across multiple emails within an email thread. The computer system can also execute the method S100: to detect invoices in emails; to distinguish authentic emails containing authentic invoices and malicious emails containing phishing invoices based on language, temporal, and security signals derived from these emails; selectively pass authentic emails to their recipients and/or a billing department within the organization; and selectively quarantine malicious emails containing phishing invoices to security personnel for review.

The method S100 is described herein as executed by the computer system to detect and handle malicious emails. However, the computer system can additionally or alternatively execute similar methods and techniques to detect and handle malicious SMS messages, MMS messages, and/or messages within a workplace communication tool, etc.

### 3. Email Ingest

Block S110 of the method S100 recites accessing (or intercepting) an email. Generally, in Block S110, the computer system intercepts an email inbound from a sender to a recipient within an email domain, computer network, or organization more generally. For example, the computer system can intercept the email at a SMTP or IMAP server before the email is delivered to the designated recipient.

The computer system can also intercept both emails inbound from outside of the domain or computer network and emails routed inside of the domain or computer network.

### 4. Email Interpretation and Language Signals

Block S120 of the method S100 recites scanning the email for a set of language signals. Generally, in Block S120, the computer system can implement language models—such as natural language processing models or natural language understanding models tuned to particular language concepts—to detect words or phrases in the email that represent key concepts indicative of a possible attack and to generate language signals based on these words or phrases, as shown in FIGS. 1A, 2A, 2B, and 3A.

### 4.1 Financial Signal

In one implementation, the computer system implements a financial signal model to detect words and phrases related to financial concepts in the email, such as: PCI, PHI, PII, and/or other types of sensitive data. For example, the computer system can implement a natural language processing model trained on a financial services and financial transaction lexicon (hereinafter a “financial signal model”) to detect words and phrases related to financial transactions in the email, such as: “bank” or “financial institution”; “DD info,” “direct deposit info,” or “direct-deposit information”; “buy a gift card”; “reimburse” or “pay you back”; and “BTC” or “Bitcoin.”

Accordingly, the computer system can generate a set of financial signals that represent the types and/or frequencies of such finance-related words and phrases detected in the email. For example, for each word or phrase detected in the email by the financial signal model, the computer system can: normalize the word or phrase; and generate one financial signal containing the normalized language value. In this example, the computer system can: normalize “DD” to “direct deposit account;” normalize “bank” to “financial institution;” normalize “pay you back” to “reimburse”; and store these normalized values in discrete financial signals for this email.

In another example, the computer system can generate one financial signal representing the presence (or absence) of all finance-related words and phrases detected in the email. In this example, the computer system can also calculate a risk value representing a risk represented by these finance-related words and phrases detected in the email, such as: proportional to frequency of finance-related words and phrases detected in the email or representing a ratio of finance-related words and phrases to other words counted in the email; or based on predefined risk rules for normalized language values. The computer system can then represent this risk value in the financial signal.

However, the computer system can implement any other method or technique to detect and represent finance-related concepts—present in the email—in a set of financial signals.

### 4.2 Sensitive Data Signal

Similarly, the computer system can implement a sensitive data model to detect words and phrases related to sensitive data in the email, such as: a username and password; bank account information (e.g., by detecting a sequence of numerical characters similar to a bank account or bank routing number); or a Social Security number. For example, the computer system can implement a natural language processing model trained on a sensitive data lexicon (hereinafter a “sensitive data model”) to detect words and phrases representing sensitive data in the email.

Accordingly, the computer system can generate a sensitive data signal that represents the types and/or frequency of such sensitive words and phrases detected in the email. For example, for each word or phrase detected in the email by the sensitive data model, the computer system can: normalize the word or phrase; and generate one sensitive data signal containing the normalized language value. In this example, the computer system can: normalize “SSN” to “Social Security Number”; normalize “handle” to “username”; normalize “passcode” to “password”; normalize “ACCT” to “account number”; and store these normalized values in discrete financial signals for this email.

In another example, the computer system generates one sensitive data signal representing presence (or absence) of sensitive words and phrases detected in the email. In this example, the computer system can also: calculate a risk value representing frequency of sensitive data detected in the email or representing a ratio of sensitive data to other words counted in the email; and represent this risk value in the sensitive data signal.

However, the computer system can implement any other method or technique to detect and represent sensitive concepts—present in the email—in a set of sensitive data signals.

### 4.3 Action Signal

Similarly, the computer system can implement an action signal model to detect words and phrases related to action requests in the email, such as: “Can the change be effective”; “Can you make this change”; “Let me know when you have made this change”; or “Can you please run over to the Safeway that's opposite our HQ and buy $2000 of iTunes gift cards?” For example, the computer system can implement a natural language processing model trained on an action request and prompt lexicon (hereinafter a “action signal model”) to detect words and phrases related to action requests in the email.

Accordingly, the computer system can generate an action signal that represents the types and/or frequency of such action-related words and phrases in the email. For example, for each word or phrase detected in the email by the action signal model, the computer system can: normalize the word or phrase; and generate one action signal containing the normalized language value. In this example, the computer system can: normalize “Can the change be effective,” “Can you make this change,” “Let me know when you have made this change,” etc. to “make a change”; and store these normalized values in discrete action signals for this email.

In another example, the computer system generates one action signal representing presence (or absence) of action requests detected in the email. The computer system can also: calculate a risk value representing frequency of action requests detected in the email or representing a ratio of action requests to other words counted in the email; and represent this risk value in the action signal.

However, the computer system can implement any other method or technique to detect and represent action-related concepts—present in the email—in a set of action signals.

### 4.4 Urgency Signal

The computer system can also implement an urgency signal model to detect words and phrases related to urgency of an action request in the email, such as: “I need”; “right now”; or “We need this today.” For example, the computer system can implement a natural language processing model trained on an urgency and social pressure lexicon (hereinafter an “urgency signal model”) to detect words and phrases related to urgency in the email.

Accordingly, the computer system can generate an urgency signal that represents the types and/or frequency of such urgency-related words and phrases in the email. For example, for each word or phrase detected in the email by the urgency signal model, the computer system can normalize the word or phrase (e.g., by normalizing “I need,” “right now,” and “We need this today” to “urgent”); and generate one financial signal containing this normalized language value.

In another example, the computer system generates one urgency signal representing presence (or absence) of urgency-related words and phrases detected in the email. The computer system can also: calculate a risk value representing frequency of urgency-related words and phrases detected in the email or representing a ratio of urgency-related words and phrases to other words counted in the email; and represent this risk value in the urgency signal.

However, the computer system can implement any other method or technique to detect and represent urgency-related concepts—present in the email—in a set of urgency signals.

### 4.5 Deadline Signal

The computer system can additionally or alternatively implement a deadline signal model to detect words and phrases indicating a deadline of an action request in the email, such as: “within the next two hours”; “within two days”; “end of day”; “EOD”; “end of week”; or “next pay date.” For example, the computer system can implement a natural language processing model trained on a deadline and time lexicon (hereinafter a “deadline signal model”) to detect words and phrases related to deadlines in the email.

Accordingly, the computer system can generate a deadline signal that represents the types and/or frequency of such deadline-related words and phrases in the email. For example, for each word or phrase detected in the email by the deadline signal model, the computer system can: normalize the word or phrase (e.g., by normalizing “within the next two hours” and “end of day” to “deadline pending”); and generate one deadline signal containing the normalized language value.

In another example, the computer system can generate one deadline signal representing presence (or absence) of deadline-related words and phrases detected in the email. The computer system can also: calculate a risk value representing frequency of deadline-related words and phrases detected in the email or representing a ratio of deadline-related words and phrases to other words counted in the email; and represent this risk value in the deadline signal.

However, the computer system can implement any other method or technique to detect and represent deadline-related concepts—present in the email—in a set of deadline signals.

### 4.6 Keyword Signal

The computer system can additionally or alternatively implement a keyword signal model to detect words and phrases in the email that are analogous (i.e., similar or identical) to stored keywords or keyphrases, such as: an internal project name specified by the organization; “NDA”; and “invoice.”

Accordingly, the computer system can generate a keyword signal that represents the types and/or frequency of such keywords and keyphrases detected in the email.

However, the computer system can implement any other method or technique to detect and represent keywords and keyphrases—present in the email—in a set of keyword signals.

### 4.7 Email Subject Line and Attachments

The computer system can thus implement various signal models to detect concepts in the body of the email and to generate language signals accordingly.

The computer system can similarly implement these signal models to detect concepts in the subject line of the email and to generate language signals accordingly.

Additionally or alternatively, the computer system can implement these signal models to detect concepts in the attachment in this email and to generate language signals accordingly. For example, the computer system can scan the email for attachments. In response to detecting an attachment in the email, the computer system can extract a set of characters from the attachment, such as by implementing optical character recognition to extract letters, words, and phrases from the attachment. The computer system can then implement methods and techniques described herein to: scan the set of characters for the set of language signals; correlate a sequence of words, in the attachment, with a language signal; and calculate a risk for the email based on a combination of language signals (e.g., financial, action request, and other signals) detected in the email body with language signals detected in the set of characters extracted from the attachment.

### 4.8 Email Signal Container

The computer system can then aggregate these language signals (e.g., all financial, action, urgency, deadline, and keyword signals, etc.) extracted from the current email into an email signal container. The computer system can also write email metadata to this email signal container, such as: a sender email address; a recipient email address; and a timestamp of the email.

Therefore, the computer system can generate an email signal container that defines a compressed representation of critical language concepts contained in the current email and that may be indicative of malicious intent of the email.

The computer system can also store this email signal container in an email signal database.

### 5. Impersonation Signal

Blocks S140 and S142 of the method S100 recite: retrieving a verified email address including a display name analogous to a sender display name of the sender address; and deriving an impersonation signal based on a difference between the verified email address and the sender address. Generally, in Blocks S140 and S142, the computer system can predict an attempt to impersonate another entity—such as within or outside of the organization—with a spoofed email address or spoofed email display name, as shown in FIGS. 1B, 2C, and 3B.

In one implementation, the computer system: extracts a sender display name and a sender email address from the email; and queries a database of verified email addresses of individuals within the organization for a display name identical or similar to the sender display name. For example, for a sender display name “John A. Smith,” the computer system can scan the database of email addresses for display names including: “John Smith”; “Jon Smith”; “Jon A. Smith”; “Johnny Smith”; “Jonny Smith”; “J. A. Smith”; “J. Smith”; and “John A Smith”; etc.

In this implementation, upon detecting a verified email address linked to a display name that is similar or identical to the sender display name, the computer system compares the verified email address to the sender email address. If the verified email address and the sender email address differ, the computer system can flag the sender email address as a possible impersonation attempt and generate an impersonation signal that reflects this possibility.

The computer system can then write this impersonation signal to the email signal container for this email.

### 5.1 VIP Impersonation

In this implementation, if the computer system matches the sender display name to the display name of a very important person within the organization (e.g., a CEO, CTO, or CFO, or VP within the organization) but detects a difference between the sender email address and the corresponding verified email address, the computer system can generate a higher-amplitude (i.e., “stronger”) impersonation signal to reflect greater risk and likelihood of malicious impersonation of very important persons within organizations.

### 6. Historical Communication Frequency Signal

Block S130 of the method S100 recites deriving a communication frequency signal based on a frequency of past communications between a sender address of the email and a recipient address of the email. Generally, in Block S130, the computer system can characterize past communications between the sender and recipient of the email, predict risk of an attack attempt within the email inversely proportional to quantity and/or frequency of past communications between the sender and recipient, and generate a communication frequency signal that reflects this risk, as shown in FIGS. 1B, 2C, and 3B.

In one implementation, the computer system queries the historical email signal database—containing email signal containers of past emails inbound to and outbound from the organization—for a set of email signal containers containing the sender and recipient email addresses of the current email. The computer system can then calculate a total count of emails, a total count of email threads, and/or frequency of emails (e.g., a number of emails sent per day, week, or month) previously exchanged between the sender and recipient email addresses prior to the current email.

Then, if the total count of emails previously exchanged between the sender and recipient email addresses is null, the computer system can predict a very-high risk of an attack attempt within the email. Similarly, if no emails were exchanged between the sender and recipient email addresses until the preceding 24-hour period in which multiple emails were sent from the sender email address to the recipient email address, the computer system can predict a high risk of an attack attempt within the email. Similarly, if the frequency of emails previously exchanged between the sender and recipient email addresses over a long period of time is low (e.g., two emails per year) but the count of emails exchanged between the sender and recipient email addresses within a recent short period of time is relatively high (e.g., three emails within the past 24 hours), the computer system can predict a moderate risk of an attack attempt within the email.

Conversely, if emails have been exchanged between the sender and recipient email addresses at a consistent frequency over a long duration of time (e.g., months), the computer system can predict a low risk of an attack attempt within the email.

The computer system can then write a communication frequency signal to the email signal container reflecting such risk for the current email.

### 7. Historical Communication Characteristic Signal

In one variation, the computer system further characterizes types of past communications between the sender and recipient email addresses based on language signals detected in past emails therebetween.

In one implementation, the computer system queries the historical email signal database for a set of email signal containers containing the sender and recipient email addresses of the current email, as described above. The computer system can then: extract a set of historical language signals from each email signal container in this set; derive historical trends in language signals contained in these past email signal containers (e.g., frequency of individual financial, action, urgency, deadline, and keyword signals, etc. and combinations thereof across these past emails); and compare these historical trends to the set of language signals extracted from the current email. Accordingly, the computer system can: quantify a communication characteristic risk proportional to deviation of the set of language signals of the current email from these historical trends; and write a communication characteristic signal reflecting this risk to the email signal container for the current email.

For example, the computer system can derive historical trends in language signals contained in these past email signal containers including: no financial signals in past emails exchanged between the sender and recipient email addresses; urgency and deadline signals in less than 20% of past emails exchanged between the sender and recipient email addresses; and/or action signals in 80% of past emails exchanged between the sender and recipient email addresses. Thus, if the current email includes financial, urgency, deadline, and action signals, the computer system can: interpret a minimum action-related risk from the action signal in the current email; interpret a moderate urgency and deadline-related risk from the urgency and deadline signals in the current email; interpret a high finance-related risk from the financial signal in the current email; and compile (e.g., sum) these risks into a composite risk score. The computer system can then write a communication characteristic signal reflecting this composite risk score to the email signal container for the current email.

### 8. Email Authentication Signal

In one variation as shown in FIGS. 1B, 2C, and 3B, the computer system: accesses email authentication (e.g., DKIM, SPF, DKIM alignment, SPF alignment, and/or DMARC) metrics for the email; compiles these metrics into a risk value; and writes an email authentication signal reflecting this risk to the email signal container for the current email.

Alternatively, the computer system can write a set of email authentication signals reflecting the discrete email authentication metrics to the email signal container for the current email.

### 9. Domain Authentication Signal

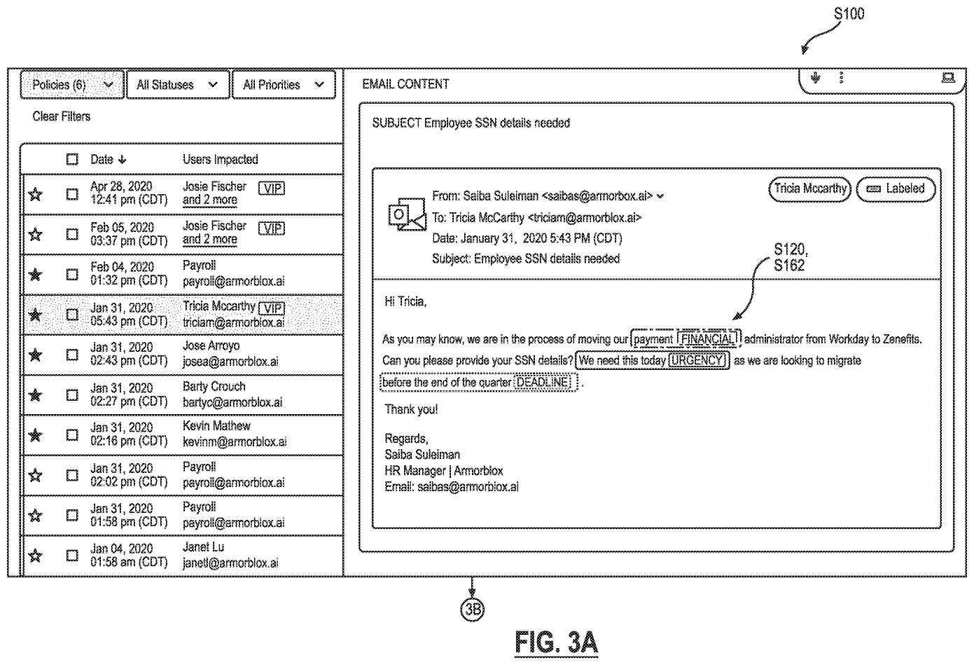

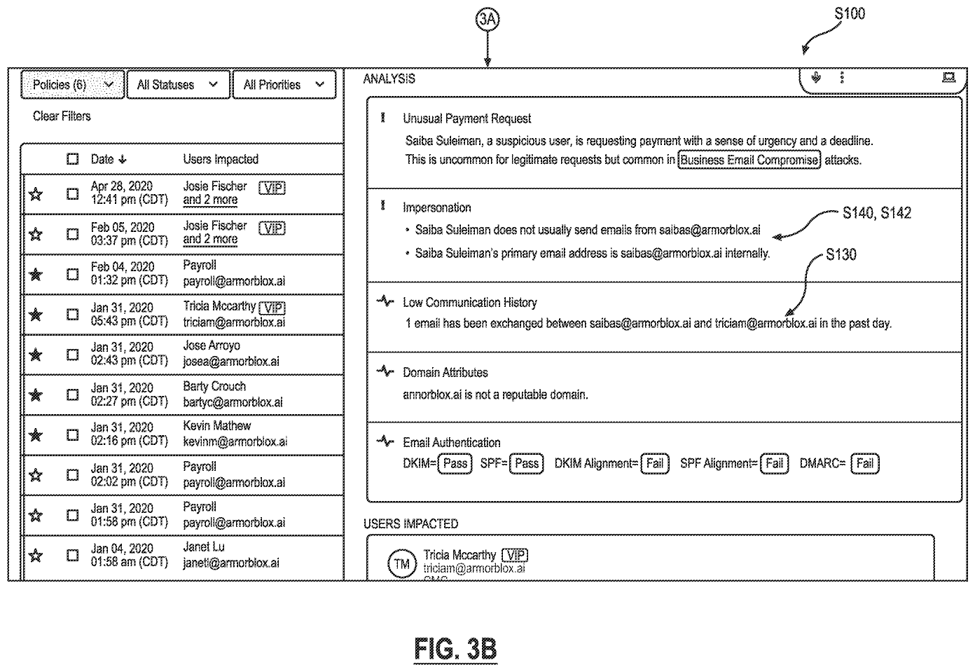

In a similar variation as shown in FIG. 3B, the computer system can: extract the domain from the sender email address and/or extract domain attributes from metadata of the current email; verify that the sender email address includes a reputable domain; calculate high risk if the sender email does not include a reputable domain; and write a domain authentication signal reflecting this risk to the email signal container for the current email.

### 10. Attack Detection

Block S150 of the method S100 recites calculating a risk for the email representing a financial attack based on a combination of the set of language signals, the communication frequency signal, and the impersonation signal. Generally, in Block S150, the computer system can fuse language, impersonation, communication frequency, communication characteristic, email authentication, and/or domain authentication signals, etc.—thus derived from the current email and stored in the current email signal container—into a prediction for whether the email is benign and/or into a prediction for a type of attack attempted in this email.

In particular, in Block S150, the computer system can implement a risk model to fuse these signals into a risk (or “risk score”) representing a confidence (or “confidence score”) that the email represents a security threat to the recipient or domain more generally.

### 10.1 Examples

In one example, the computer system detects multiple financial signals and an action request signal in the email. In this example, the computer system can implement methods and techniques described above to: access a first natural language processing model trained on a financial services and financial transaction lexicon; identify a first sequence of words, related to financial transactions, in the email based on the first natural language processing model; normalize the first sequence of words to a first standard financial transaction language concept; represent the first standard financial transaction language concept in the financial signal; and annotate the first sequence of words in the email according to a first visual highlighting scheme associated with financial language signals. Similarly, in this example, the computer system can implement methods and techniques described above to: identify a second sequence of words, related to financial transactions, in the email based on the first natural language processing model; normalize the second sequence of words to a second standard financial transaction language concept; represent the second standard financial transaction language concept in a second financial signal; and annotate the second sequence of words in the email according to the first visual highlighting scheme. Furthermore, in this example, the computer system can: access a second natural language processing model trained on an action request and prompt lexicon; identify a third sequence of words, describing an action request, in the email based on the second natural language processing model; normalize the third sequence of words to a standard action request language concept; represent the standard action request language concept in the action request signal; and annotate the first sequence of words in the email according to a first visual highlighting scheme associated with action request language signals.

Additionally or alternatively, the computer system can: access a third natural language processing model trained on a sensitive data lexicon; identify a fourth sequence of words, describing sensitive personal information, in the email based on the third natural language processing model; normalize the fourth sequence of words to a standard sensitive data language concept; represent the standard sensitive data language concept in a sensitive data signal; and annotate the fourth sequence of words in the email according to a third visual highlighting scheme associated with the sensitive data signal and different from the first and second visual highlighting schemes.

Additionally or alternatively, the computer system can: access a fourth natural language processing model trained on an urgency and deadline lexicon; identify a fifth sequence of words, describing urgency of the standard action request, in the email based on the fourth natural language processing model; normalize the fifth sequence of words to a standard urgency language concept; represent the standard urgency language concept in an urgency data signal; and annotate the fifth sequence of words in the email according to a fourth visual highlighting scheme associated with the urgency signal and different from the first, second, and third visual highlighting schemes.

Additionally or alternatively, the computer system can: extract a sender address from the email; query an historical email database for a frequency of historical email communications between the sender address and the recipient addresses; and represent the frequency of historical email communications in a historical communication signal.

The computer system can then calculate the risk for the email based on: the combination of the financial signal, the second financial signal, the action request signal, the sensitive data signal, and/or the urgency signal detected in the email; and/or the historical communication signal derived by the computer system based on historical communications between the sender and the recipient.

### 10.1 Attack Matching by Template Matching

In one implementation, the computer system accesses a database of attack templates, wherein each attack template: represents and is labeled with a known attack type; and specifies a set of requisite signals and a set of likely signals that cooperate to form an email-based attack of this known attack type.

More specifically, in this implementation, the computer system can access a database of attack templates, wherein each attack template in the database: represents a known attack type; is labeled with a risk score; and specifies a set of signals indicative of an email-based attack of the known attack type. For example, the computer system (or other computing device or computer network) can generate attack templates based on: similarities of signals detected in known malicious email-based attacks of similar types; and dissimilarities between these known malicious email-based attacks and benign email threads. The computer system can then: compare signals (e.g., a financial signal and an action request signal) detected in the email to signals specified in attack templates in the database; and match these signals detected in the email to a set of signals specified in a particular attack template of a particular attack type, such as by matching type, confidence, frequency, and order of signals detected in the email to signals represented in the particular attack template. The computer system can then: read a particular risk score from the particular attack template; and set or calculate a risk for the email based on the particular risk score.

For example, the database of attack templates can include one or more attack templates specifying combinations of requisite and likely signals that represent each of: “payroll fraud”; “VIP impersonation”; “advance fee scheme”; “business email compromise”; “business fraud”; “identity theft”; “Internet fraud”; “letter of credit fraud”; “market manipulation”; “419 fraud”; “prime bank note fraud”; “ransomware”; “redemption fraud”; and “romance scam.” In this example, a payroll fraud attack template can specify: requisite language signals including a financial signal containing a “direct deposit account” value and an action signal; likely language signals including an urgency signal and a deadline signal; a likely impersonation signal; a likely communication frequency signal indicating low email communication frequency; and a likely email authentication signal indicating failed email authentication. Furthermore, in this example, an impersonation for gift card attack template can specify: requisite language signals including a financial signal containing a “reimburse” value, an action signal, an urgency signal, and a deadline signal; a requisite impersonation signal; and a likely communication frequency signal indicating low historical email communication frequency.

Accordingly, the computer system can: scan this database of attack templates for a subset of attack templates that specify requisite signals fulfilled by the signals represented in the email signal container of the current email; and isolate a particular attack template—from this set—with the greatest quantity of likely signals fulfilled by the signals indicated in the email signal container of the current email. If the computer system identifies such a match, the computer system can flag the current email as an instance of the attack type represented by the particular attack template. Otherwise, the computer system can identify the email as benign and release the email to the recipient.

### 10.2 Attack Matching by Nearest Neighbor

In a similar implementation, the computer system aggregate signals in the email signal container for the current email into an n-dimensional “target” vector, wherein each value in this n-dimensional vector represents: presence of a signal of a particular type detected in the current email; a magnitude of a signal of a particular type detected in the current email; and/or a risk that an individual signal of a particular type detected in the current email represents to the recipient or organization more generally.

The computer system can then access a corpus of vectors representing and labeled with known attack types, wherein each value in each n-dimensional vector represents: presence of a signal of a particular type detected in an email of the corresponding attack type; a magnitude of a signal of a particular type detected in an email of the corresponding attack type; and/or a risk that an individual signal of a particular type detected in an email of the corresponding attack type represents to the recipient or organization more generally. This corpus of vectors can further include vectors labeled as and representing benign or “legitimate” email communications.

The computer system can then: implement k-nearest neighbor techniques to characterize proximity of the target vector to individual vectors and/or clusters of vectors in the corpus of vectors representing known attack types; and identify a particular individual vector or a cluster of vectors representing a particular known attack type nearest the target vector. If the distance from the target vector to the particular vector or vector cluster is less than a threshold distance, the computer system can identify the email as suspicious and remediate the email. Otherwise, the computer system can release the email to the recipient.

In a similar implementation, the computer system can: calculate a risk for the current email inversely proportional to distances from the target vector to all vectors representing known attack types; and predict one or a subset of possible attack types of the current email based on the known attack type associated with the nearest one or subset of individual vectors or vector clusters.

### 10.3 Attack Matching by Ensemble Learning

In another implementation, the computer system accesses a corpus of email signal containers of previous emails (and email threads, as described below), each email labeled with a particular known attack type or labeled as benign. The computer system then implements artificial intelligence techniques to train an attack detection model based on this corpus of labeled signal groups. In particular, the computer system can train the attack detection model: to ingest a set of language, impersonation, communication frequency, communication characteristic, email authentication, and/or domain authentication signals, etc.; and to return similarities for each known attack type.

Accordingly, upon generating the email signal container for the current email, the computer system can feed signals from this email signal container—such as in the form of an n-dimensional vector as described above—into the attack detection model, which returns a set of similarities representing similarity between each known attack type and the current email. The computer system can then identify a most-likely attack type associated with a highest similarity returned by the attack detection model. If the similarity of this most-likely attack type exceeds a threshold, the computer system can: flag the current email as an instance of the corresponding attack type; store this similarity as a confidence that the current email is an instance of this attack type; and remediate the email accordingly. Otherwise, the computer system can label the current email as benign and release the email to the recipient.

### 10.3.1 Industry-Wide Attack Detection Model

In this variation, the computer system can aggregate the corpus of emails from historical email threads inbound to, outbound from, and internal to many organizations within the same industry (e.g., banking, Internet technology, or manufacturing), market sector, and/or geographic region (e.g., city, state, country), etc. as the organization. Accordingly, the computer system can construct an attack detection model specific to the industry, market sector, and/or geographic region, etc. that is representative of the organization and therefore is tuned to interpret particular signals or combinations of signals that may be most or uniquely risky for the industry, market sector, and/or geographic region containing the organization.

### 10.3.2 Organization-Specific Attack Detection Model

Similarly, in this variation, the computer system can aggregate the corpus of emails from historical email threads inbound to, outbound from, and internal to the organization specifically. Accordingly, the computer system can construct an attack detection model specific to the organization and therefore tuned to interpret particular signals or combinations of signals that maybe most or uniquely risky for the organization.

However, the computer system can implement any other method or technique to predict a type of attack represented by the current email based on language, impersonation, communication frequency, communication characteristic, email authentication, and/or domain authentication signals, etc. thus derived from this email.

### 11. Attack Response

Block S160 of the method S100 recites, in response to the risk exceeding a threshold, remediating the email prior to delivery to the recipient address. Generally, in Block S160, the computer system can selectively remediate the current email for review by security personnel or automatically block and archive the email based on the type of attack identified from signals extracted from the email, such as if a confidence that the current email represents a particular type of attack exceeds a general threshold or a threshold specific to this particular type of attack.

For example, the computer system can: quarantine the mail to the recipient's quarantine folder; soft-delete the email; permanently deleting the email; blocking the email from delivery to be recipient's email inbox; inserting a warning banner—identifying the email as malicious or suspicious—into the email; or writing a malicious or suspicious to metadata or a header of the email. In this example, the computer system can interface with an email administrator to selectively assign (or “configure”) these automatic actions for inbound emails based on their risk scores, attack types, and/or other characteristics.

The computer system can then compile signals extracted from this email into a report and serve this report to security personnel to enable rapid and accurate manual review of the email.

### 11.1 Language Signal Visualization

In one implementation shown in FIGS. 1B, 2C, and 3B, the computer system interfaces with a security portal to: render the email; and highlight, color-code, and label words and phrases in the subject line and body of the email corresponding to each language signal derived from the email. For example, the security portal can present: words corresponding to financial signals highlighted in GREEN and appended with “FINANCIAL” labels; words corresponding to action signals highlighted in PURPLE and appended with “ACTION” labels; words corresponding to urgency signals highlighted in ORANGE and appended with “URGENCY” labels; words corresponding to deadline signals highlighted in YELLOW and appended with “DEADLINE” labels; and/or words corresponding to sensitive data signals highlighted in GRAY, including Social Security numbers appended with “SSN” labels and detected bank account and routing numbers appended with “BANK ACCOUNT” labels.

The computer system and the security portal can thus cooperate to enable security personnel reviewing the remediated email to quickly identify and distinguish critical words and phrases that may indicate an attempted attack within the email.

In one implementation, if the risk calculated for the email exceeds the corresponding threshold risk, the computer system: redirects the email to a quarantine folder accessible via the security portal; and withholds the email from the recipient's inbox, quarantine, or spam folder, etc. unless manually released by security personnel. In this implementation, the computer system then: highlights a first sequence of words in the email—corresponding to a first (e.g., financial) signal with a first color (e.g., “green”) according to a first visual highlighting scheme associated with the first signal; and highlights a second sequence of words in the email—corresponding to a second (e.g., action request) signal with a second color (e.g., “red”) according to a second visual highlighting scheme associated with the second signal; etc. Then, in response to selection of the email from the quarantine folder, the security portal (or other email viewer) can: render the email with the first sequence of words highlighted in the first color and with the second sequence of words highlighted in the second color; label the first color as corresponding to the first signal type (e.g., a financial signal); and label the second color as corresponding to the second signal type (e.g., an action request signal).

### 11.2 Temporal and Security Signal Report

As shown in FIGS. 1B, 2C, and 3B, the computer system can further cooperate with the security portal to present impersonation, communication frequency, communication characteristic, email authentication, and/or domain authentication signals, etc. and thus present further context for risk indicators in the email.

### 11.3 Attack Type Label

Similarly, the computer system can further cooperate with the security portal to indicate the attack type thus predicted for the current email, as shown in FIGS. 1B, 2C, and 3B.

### 12. Risk Threshold Selection

In one variation shown in FIG. 4, the computer system selects a risk threshold for the email based on characteristics or attributes of the recipient. In particular, various recipients within a domain may exhibit different susceptibilities to email-based attacks of different types, such as due to their experience levels and roles within the domain. Accordingly, the computer system can set or adjust risk thresholds for individual email recipients.

### 12.1 Quantitative Recipient Attribute

In one implementation, the computer system sets the risk threshold proportional to: a duration of time that the recipient has been affiliated with the domain or a member of the domain; a time since the recipient was last a victim of a successful email-based attack; and/or a time since the computer system quarantined a last email to the recipient. Thus, the system can set a low risk threshold if the recipient is new to the domain or was recently a victim of a successful email-based attack.

### 12.2 Qualitative Recipient Attribute

In another implementation, the computer system: intercepts the email inbound to a recipient address within an email domain; retrieves an attribute of a recipient associated with the recipient address; accesses a risk schedule specifying a set of threshold risks, each threshold risk in the set of threshold risks associated with a unique combination of recipient attributes and based on malicious targeting frequency of recipients represented by the unique combination of recipient attributes within the email domain; and selects the threshold risk, from the risk schedule, based on the attribute of the recipient. For example, the risk schedule can specify lower risk thresholds—thereby triggering email quarantine for lower-risk emails—for recipients with human resources and accounting responsibilities within the domain (e.g., labeled with “human resources” or “accounting” attributes). Similarly, the risk schedule can specify higher risk thresholds—thereby triggering email quarantine for only high-risk emails—for email administrators and security personnel trained to detect email-based attacks. Therefore, in this implementation, the computer system can set the threshold risk for the email based on the recipient attribute and predefined threshold risks linked to attributes in the risk schedule.

### 12.3 Qualitative Recipient Attribute+Attack Type

In a similar implementation, the computer system can set the threshold risk for the email further based on an attack type of the email. In particular: recipients with “human resources” attributes may be most susceptible to fraudulent direct deposit change orders; recipients with “accounting” attributes may be most susceptible to fraudulent invoices; recipients with “intern” attributes may be most susceptible to social engineering attacks; and recipients with “executive” attributes may be most susceptible to spam. Conversely, recipients with “accounting” attributes may be only slightly susceptible to social engineering attacks; and recipients with “intern” attributes maybe least susceptible to fraudulent direct deposit change orders and fraudulent invoices due to lack of access to corresponding systems. Accordingly, the computer system can represent susceptibilities of recipients—of a particular set of attributes—to email-based attacks of different types in a risk profile associated with this set of attributes. More specifically, the computer system can generate and/or access a corpus of risk profiles, wherein each risk profile: is associated with a unique combination of recipient attributes, such as described above; and can define different risk thresholds for different email-based attack types for recipients exhibiting these recipient attributes.

For example, the computer system can: aggregate signals (e.g., a financial, action request, and urgency signal) into a target vector; access a corpus of stored vectors representing and labeled with known email-based attack types; identify a particular vector—in the corpus of stored vectors—nearest the target vector in a multi-dimensional feature space; characterize a distance between the particular vector and the target vector in the multi-dimensional feature space; calculate a risk for the email inversely proportional to this distance; and predict a type of email-based attack represented by the email based on a known attack type of the particular vector.

In this example, the computer system can then: retrieve an attribute of a recipient associated with the recipient address; and access the corpus of risk profiles, each associated with a set of recipient attributes and specifying risk thresholds for a set of known email-based attack types based on the set of attributes. The computer system can then: associate the recipient address with a particular risk profile, in the corpus of risk profiles, based on the attribute (e.g., by matching the attribute of the recipient to a set of attributes associated with the particular risk profile); query the particular risk profile for a risk threshold associated with the particular email-based attack type represented by the particular vector; and assign this risk threshold to the email.

Then, if the risk of the email exceeds this risk threshold, the computer system can redirect the email to a quarantine folder as described above.

### 13. Recipient Inbox to Recipient Quarantine

In one variation, if the risk calculated for the email exceeds the threshold risk (e.g., a fixed risk threshold, a risk threshold assigned to an attack type of the email, a risk threshold set based on attributes of the recipient), the computer system redirects the email: from an email inbox within an email account at the recipient address; to a quarantine folder within the email account at the recipient address.

In one implementation, an email viewer associated with the email account at the recipient address can then: present the email to the recipient upon selection of the email from the quarantine folder; render a flag or warning that the email represents a possible attack; and selectively highlight phrases in the email corresponding to various language signals detected in the email. More specifically, in response to selection of the email from the quarantine folder, the email viewer can render the email: with a risk alert; with a first sequence of words corresponding to a first language signal highlighted according to a first visual highlighting scheme; and with a second sequence of words corresponding to a second language signal highlighted according to the second visual highlighting scheme; etc.

Like the security portal described above, the quarantine folder can present a user interface for confirmed malintent of emails loaded into the quarantine folder at the recipient's address. The recipient may then confirm the email is malicious via the user interface within the quarantine folder or by forwarding the email to the security portal or other email security administrator. Alternatively, the recipient may confirm the email is benign via the user interface within the quarantine folder or by moving the email into her email inbox. The computer system can then: log this response from the recipient; label the email with this response; and implement methods and techniques described below to retrain the risk model to reflect malintent or benign characteristics of the email thus confirmed by the recipient.

In this implementation, the computer system can later implement methods and techniques described above to: intercept a second email inbound to the recipient address; scan a second body of the second email for the set of language signals; correlate a third sequence of words, in the email, with the financial signal; correlate a fourth sequence of words, in the email, with the action request signal; and calculate a second risk for the second email representing a second financial attack based on a second combination of the financial signal and the action request signal detected in the second email. Then, in response to the second risk falling below the threshold risk, the computer system can: annotate the third sequence of words in the second email according to the first visual highlighting scheme associated with the financial signal; annotate the fourth sequence of words in the second email according to the second visual highlighting scheme associated with the action request signal; and release the second email to an email inbox within the email account at the recipient address. Furthermore, in response to selection of the second email from the email inbox, the email viewer can render the second email with the third sequence of words highlighted according to the first visual highlighting scheme and with the fourth sequence of words highlighted according to the second visual highlighting scheme.

Therefore, in this implementation, the email viewer can highlight language signals in a first email characterized as malicious in order to enable the recipient to quickly identify an attack vector of the first email and verify malintent of the first email. The email viewer can implement similar methods and techniques to highlight language signals in a second email characterized as benign in order to enable the recipient to quickly review and extract critical information from the second email, thereby enabling the recipient to improve her email comprehension and email review efficiency.

### 13.1 Recipient Quarantine+Security Portal

In this variation, if the risk calculated for the email exceeds the threshold risk, the computer system can both: redirect the email to the quarantine folder within the recipient's email account; and load the email into the security portal. If security personnel review the email prior to the recipient and confirm the email is malicious, the computer system can automatically remove the email from the recipient's quarantine folder and discard the email from the recipient's email account. Similarly, if security personnel review the email prior to the recipient and confirm the email is benign, the computer system can automatically return the email to the recipient's inbox. Alternatively, if the recipient reviews the email prior to security personnel and confirms the email is malicious, the computer system can automatically remove the email from recipient's quarantine folder and generate a low-urgency ticket for the security portal to review the email. However, if the recipient reviews the email prior to security personnel and confirms the email is benign, the computer system can return the email to the recipient's inbox but generate a high-urgency ticket for security personnel to confirm this action. In each of these scenarios the computer system can also queue the risk model for retraining based on attributes of the email thus confirmed by the recipient and/or security personnel.

Therefore, in this implementation, the computer system can: redirect the email to the security portal and the recipient's quarantine folder if the risk of the email exceeds the risk threshold; and then selectively discard the email, return the email to the recipient's inbox, and/or queue the risk model for retraining based on feedback supplied by the recipient and/or security personnel.

For example, in response to the risk of the email exceeding the threshold risk, the computer system can: redirect the email from an email inbox to the quarantine folder within an email account at the recipient address; and load the email into an administrator folder. In response to selection of the email from the administrator folder, an administrator email viewer (e.g., within the security portal) can: render the email with the first sequence of words highlighted in the first color according to the first visual highlighting scheme and with the second sequence of words highlighted in the second color according to the second visual highlighting scheme; label the first color as corresponding to the financial signal; and label the second color as corresponding to the action request signal. Then, in response to manual identification of the email as malicious within the administrator email viewer prior to review of the email in the quarantine folder, the computer system can discard the email from the quarantine folder within the email account at the recipient address. Conversely, in response to manual identification of the email as benign within the administrator email viewer prior to review of the email in the quarantine folder, the computer system can transfer the email from the quarantine folder to the email inbox within the email account at the recipient address.

### 12. Invoices

In one variation, in response to detecting an “invoice” keyword in the current email, the computer system: implements the foregoing methods and techniques to check the email for an attack type; selectively remediate the email if identified as likely representing an attack; and selectively passes the email to the recipient and/or another entity within the organization for invoice handling if the email is identified as benign or validated.

In one example, the computer system implements the foregoing methods and techniques to: detect an “invoice” keyword found in the email; authenticate the sender email address and domain; and confirm email communication history between the sender and the recipient including the “invoice” keyword. Accordingly, the computer system validates the email (e.g., by passing the email signal container for this email into the attack detection model). The computer system then: retrieves a list of approved vendors for the organization; identifies the sender email address and/or the sender domain in this list of approved vendors; retrieves invoice rules specified for this vendor by the organization; and selectively passes the email to the recipient, forwards the email to a billing department, and automatically initiates payment according to data extracted from the invoice in the email based on these rules for the vendor.

Conversely, in a similar example, if the computer system detects lack of sender and recipient communication history including the “invoice” keyword, the computer system can forward the email to the billing department for review because the recipient has not previously managed an invoice from this vendor.

Alternatively, if the computer system fails to identify the sender email address or the sender domain in the list of approved vendors and if the sender and the recipient have extensive communication history, the computer system can forward the email to the billing department for review, such as to manually add the vendor to the list of approved vendors or flag the email as a phishing attack.

Furthermore, in this example, if the computer system determines that the sender email address and the sender domain are not present in the list of approved vendors, the sender and recipient have no or minimal communication history, and the sender email address is not verified, the computer system can: identify the email as a likely attack; and remediate the email, as described above.

### 13. Model Training

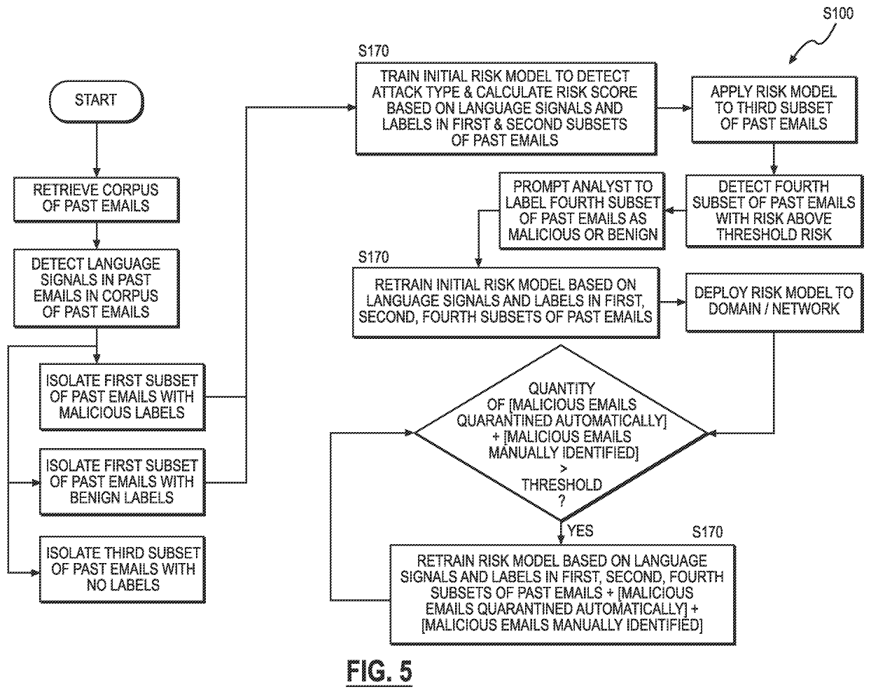

As described above and shown in FIG. 5, the computer system can develop (or “train”) the risk model in Block S170 based on past emails inbound to the domain (and/or multiple domains), including based on language signals detected in these emails by the natural language processing models described above and benign and/or malicious labels stored with these emails.

In one implementation shown in FIG. 5, when the method S100 is deployed on the domain, the computer system: accesses a corpus of past emails inbound to recipients within the email domain, including a first subset of past emails labeled as malicious and a second subset of past emails labeled as benign; implements methods and techniques described above to detect language (e.g., financial, action request) signals in the corpus of past emails: and then trains a risk model—unique to the domain—based on the first subset of past emails labeled as malicious, the second subset of past emails labeled as benign, and language signals detected in these past emails. In particular, the computer system can train the risk model to return a risk score based on language signals detected in an inbound email. For example, the computer system can implement artificial intelligence, machine learning, and/or regression techniques to train a neural network to calculate a confidence score that an email represents a threat to the network (or “risk”)—such as as a function of type, confidence, frequency, and/or order of signals detected in the email by the natural language processing models described above—based on language signals detected in and labels stored in the corpus of past emails. Later, the computer system can insert language signals—extracted from the email—into the risk model to calculate a risk for the email.

Therefore, the computer system can first train natural language processing model to detect language signals in bodies, subject lines, and/or attachments in emails based on language signals labeled in the corpus of past emails. For example, the computer system can implement artificial intelligence, machine learning, and/or regression techniques to: train a financial signal model to calculate a confidence score that each word or phrase (i.e., sequence of one or more words) in an email body, subject, and/or attachment corresponds to or represents a financial signal; and train an action request signal model to calculate a confidence score that each word or phrase in an email body, subject, and/or attachment corresponds to or represents an action request signal.

The computer system can then train the risk model to calculate a risk score for an email based on: confidence scores for signal types detected in the corpus of past emails by these natural language processing models; and benign and attack type labels stored or associated with these emails.

Then, for a new inbound email, the computer system can implement methods and techniques described above to: calculate confidence scores that words and/or phrases in the email represent corresponding language signal types based on the natural language processing model; insert confidence scores for these language signals into the risk model; and record risks (e.g., confidence scores for risk) that the email represents a malicious attack on the recipient.

### 13.1 Iterative Model Training

In one variation, the computer system can implement the foregoing methods and techniques to initialize the risk model based on the first subset of past emails labeled as malicious, the second subset of past emails labeled as benign, and language signals detected in the corpus of past emails. The computer system can also isolate a third subset of past emails ^{o} in the corpus of past emails—that exclude malicious and benign labels. Then, for each past email in the third subset of past emails, the computer system can implement methods and techniques described above to: scan a past body of the past email for language signals; and insert language signals—extracted from the past email—into the risk model to calculate a past risk for the past email. The computer system can then identify a fourth subset of past emails—from the third subset of past emails—associated with past risks exceeding the threshold risk. Accordingly, for each past email in the fourth subset of past emails, the computer system can: generate a prompt to investigate the past email; serve the prompt to an administrator; and label the past email according to a response supplied by the administrator.

The computer system can then retrain the risk model based on the first subset of past emails, the second subset of past emails, the fourth subset of past emails, and financial signals and action request signals detected in emails in the corpus of past emails.

### 12. Model Retraining

In one variation, if the computer system fails to identify a malicious email as an attack and erroneously passes the email to the recipient (i.e., a false negative), the recipient may manually identify the email as fraudulent and report the email to security personnel. The security personnel may then: review the email; identify the email as fraudulent; write an attack type label to this email; manually select a set of words or phrases in the email body, subject line, or across the email thread that indicate malicious intent; and write language signal labels (e.g., “FINANCIAL,” “ACTION,” “URGENCY,” and/or “DEADLINE” signal labels) to these words or phrases.

The computer system then: creates a new email signal container for this email based on these attack type and language signal inputs from the security personnel or updates an existing email signal container for this email to include these attack type and language signal inputs. The computer system can then update (or “retrain”) the language models described above to detect new words or phrases thus selected from the email by the security personnel.

Additionally or alternatively, the computer system can: add this updated email signal container to the corpus of past emails and retrain the attack detection model described above based on this corpus of emails—and thus further based on this newly-identified fraudulent email. Once the attack detection model is retrained on this email, the computer system can rescan emails (or email signal containers previously generated and stored for emails) in inboxes within the organization and received within a past time period (e.g., up to 48 hours prior to receipt of the newly-identified fraudulent email).

Therefore, the security personnel may need only verify that the email is fraudulent, supply a descriptor for an attack type, and highlight critical language concepts in the newly-identified fraudulent email. The computer system can then update the attack detection model accordingly and rescan email inboxes across the organization and/or recent email signal containers for other emails exhibiting characteristics of the same or similar attack type.

Similarly, the security personnel may review an email in quarantine, indicate that the email is not malicious, release the email to its recipient, and elect to prevent quarantine of similar emails in the future. The computer system can therefore: retrieve or generate an email signal container for this email; write a benign flag to this email signal container; add this email signal container to the corpus of past emails; and retrain the attack detection model based on this updated corpus of emails—and thus further based on this email thus identified as benign.

### 13. Email Thread

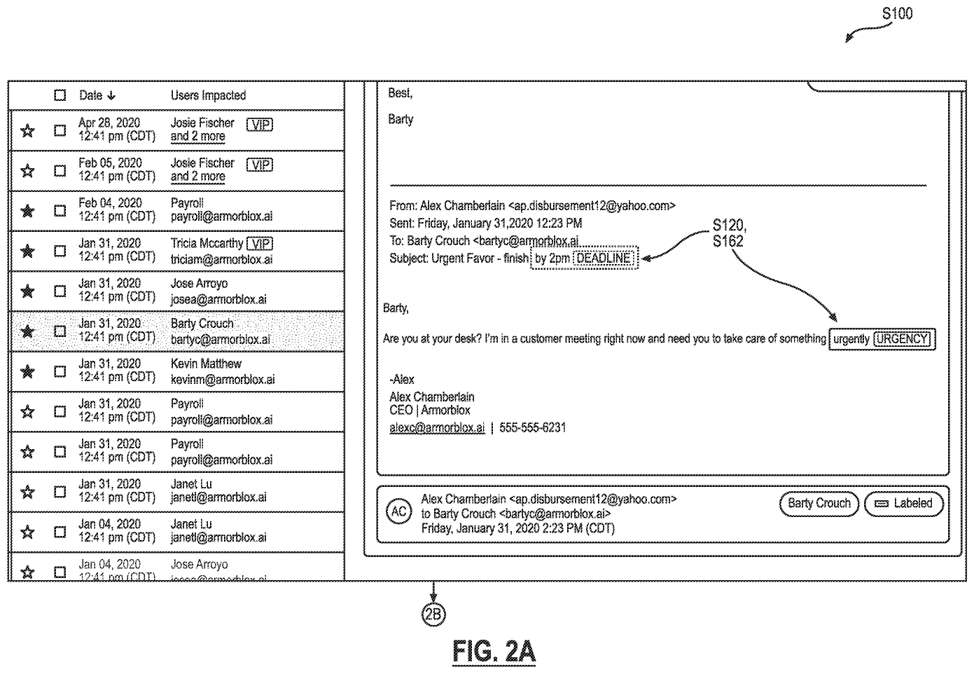

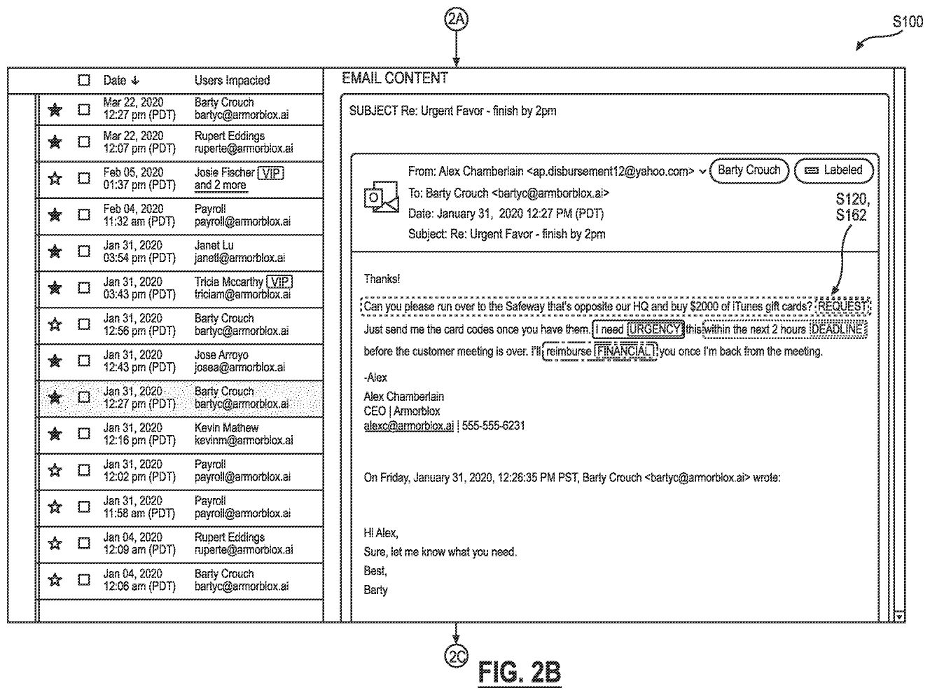

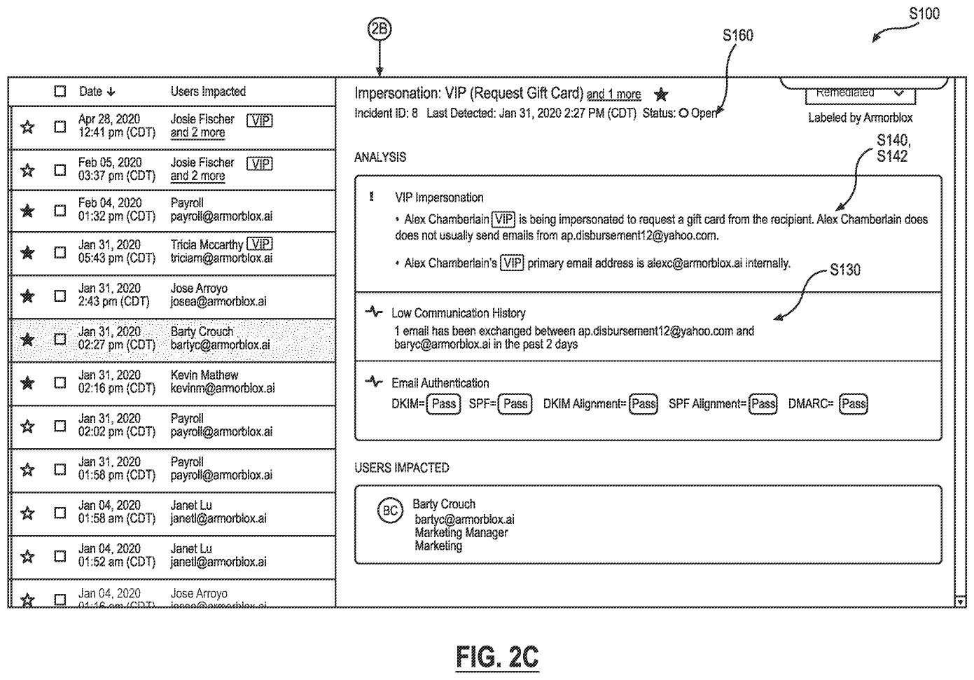

In one variation shown in FIGS. 2A-2C, the computer system implements methods and techniques described above across a thread of multiple emails sent between a sender and a recipient.

### 13.1 Email Thread in Email Body

In one implementation, the computer system intercepts an email that includes past email content (i.e., an “email thread”) below a main body of text in the email. Accordingly, the computer system implements methods and techniques described above to scan the entire email—including previous email bodies within the same email thread—for various language signals, etc. and stores these email signals in one email signal container for the email thread.

In this implementation, the computer system can also: separate these language signals by sender and recipient; aggregate a first group of language signals extracted from email bodies sent from a first email address (or domain, email handle, or display name) represented in this email; and aggregate a second group of all language signals extracted from email bodies from a second email address (or domain, email handle, or display name) in this email.

The computer system can then implement methods and techniques described above to fuse these intra-email-thread language, impersonation, communication frequency, communication characteristic, email authentication, and/or domain authentication signals, etc. derived from this email thread into a prediction that the email thread represents an attempted attack on the recipient or the organization more generally.

### 13.2 Email Thread Over Sequential Emails

In another implementation, the computer system implements methods and techniques described above to: intercept a first email; extract language, impersonation, communication frequency, communication characteristic, email authentication, and/or domain authentication signals, etc. from the first email; aggregate these signals into a first email signal container for this first email; and characterize a first risk of the first email based on signals represented in this first email signal container. If the first risk of the first email is less than a threshold risk, the computer system can: write a reference identifier from the reference header of the first email, a sender email address, a recipient email address, and/or a subject line of the first email to the first email signal container; and store this first email signal container in the email signal database described above.

Later, the computer system can implement methods and techniques described above to: intercept a second email; extract language, impersonation, communication frequency, communication characteristic, email authentication, and/or domain authentication signals, etc. from the second email; aggregate these signals into a second email signal container for this second email; and characterize a second risk of the second email based on signals represented in this second email signal container. If the second risk of the second email is less than the threshold risk, the computer system can: extract a reference identifier from the reference header of the second email, a sender email address, a recipient email address, and/or a subject line of the second email from the second email; and query the email signal database for an email signal container containing the same or similar reference identifiers, sender and recipient email addresses, and/or subject line.

Upon detecting correspondence between reference identifiers, sender and recipient email addresses, and/or subject line for the first and second email signal containers, the computer system can: determine that the first and second emails correspond to a common or related email thread; compile the first and second groups of signals into a composite email signal container that reflects signals extracted from both the first and second emails; and implement methods and techniques described above to characterize a composite risk of this email thread based on the composite group of signals. Thus, if this composite risk of the email thread is less than a threshold risk, the computer system can store the composite group of signals in the email signal database and repeat the foregoing process for subsequent emails inbound to the organization. Conversely, if the composite risk of the email thread is greater than the threshold risk, the computer system can quarantine the second email (and first email, and the entirety of the email thread).

For example, the computer system can: intercept a first email inbound to the recipient address at a first time; scan a first body of the first email for a set of language signals; correlate a first sequence of words, in the first email, with a first signal in the set of language signals; correlate a second sequence of words, in the first email, with a second signal in the set of language signals; and calculate a first risk for the first email representing a first financial attack based on a first combination of the first signal and the second signal detected in the first email. Then, in response to the first risk falling below the threshold risk, the computer system can release the first email to an email inbox within an email account at the recipient address.

Later, the computer system can: intercept a second email—from the same sender and inbound to the recipient address—at a second time succeeding the first time; correlate a third sequence of words, in the second email, with a third signal in the set of language signals; correlate a fourth sequence of words, in the second email, with a fourth signal in the set of language signals; and then identify the first and second emails as forming an email thread, such as based on common sender addresses, subject lines, and/or metadata within the first and second emails.

Then, responsive to identifying the first and second emails as forming an email thread, the computer system can calculate the risk for the email thread representing a risk to the recipient (or the domain more generally) based on a combination of: the language signals detected in the first email; and the language signals detected in the second email. In response to the risk of this email thread exceeding the threshold risk, the computer system can: transfer the first email from the email inbox to the quarantine folder within the email account at the recipient address; and redirect the second email to the quarantine folder within the email account at the recipient address and/or redirect the second email to the security portal.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for detecting financial attacks in emails comprising:
accessing an email inbound to a recipient address;
scanning a body of the email for a set of language signals;
correlating a first sequence of words, in the email, with a financial signal in the set of language signals;
correlating a second sequence of words, in the email, with an action request signal in the set of language signals;
calculating a risk for the email representing a financial attack based on a combination of the financial signal and the action request signal detected in the email; and
in response to the risk exceeding a threshold risk:
annotating the first sequence of words in the email according to a first visual highlighting scheme associated with the financial signal;
annotating the second sequence of words in the email according to a second visual highlighting scheme associated with the action request signal, the second visual highlighting scheme different from the first visual highlighting scheme; and
redirecting the email to a quarantine folder.

2. The method of claim 1:
wherein accessing the email comprises intercepting the email inbound to the recipient address within an email domain; and
further comprising:
retrieving an attribute of a recipient associated with the recipient address;
accessing a risk schedule specifying a set of threshold risks, each threshold risk in the set of threshold risks associated with a unique combination of recipient attributes and based on malicious targeting frequency of recipients represented by the unique combination of recipient attributes within the email domain; and
selecting the threshold risk, from the risk schedule, based on the attribute of the recipient.

3. The method of claim 1:
wherein annotating the first sequence of words in the email according to the first visual highlighting scheme comprises highlighting the first sequence of words in the email with a first color according to the first visual highlighting scheme;
wherein annotating the second sequence of words in the email according to the second visual highlighting scheme comprises highlighting the second sequence of words in the email with a second color, different from the first color, according to the second visual highlighting scheme; and
further comprising, within an email viewer, in response to selection of the email from the quarantine folder:
rendering the email with the first sequence of words highlighted in the first color and with the second sequence of words highlighted in the second color;
labeling the first color as corresponding to the financial signal; and
labeling the second color as corresponding to the action request signal.

4. The method of claim 1, further comprising:
wherein redirecting the email to the quarantine folder comprises redirecting the email from an email inbox to the quarantine folder within an email account at the recipient address; and
further comprising:
in response to selection of the email from the quarantine folder, rendering the email with a risk alert, with the first sequence of words highlighted according to the first visual highlighting scheme, and with the second sequence of words highlighted according to the second visual highlighting scheme;
intercepting a second email inbound to the recipient address;
scanning a second body of the second email for the set of language signals;
correlating a third sequence of words, in the second email, with the financial signal;
correlating a fourth sequence of words, in the second email, with the action request signal;
calculating a second risk for the second email representing a second financial attack based on a second combination of the financial signal and the action request signal detected in the second email;
in response to the second risk falling below the threshold risk:
annotating the third sequence of words in the second email according to the first visual highlighting scheme associated with the financial signal;
annotating the fourth sequence of words in the second email according to the second visual highlighting scheme associated with the action request signal; and
releasing the second email to an email inbox within the email account at the recipient address; and
in response to selection of the second email from the email inbox, rendering the second email with the third sequence of words highlighted according to the first visual highlighting scheme and with the fourth sequence of words highlighted according to the second visual highlighting scheme.

5. The method of claim 1:
wherein redirecting the email to the quarantine folder comprises redirecting the email from an email inbox to the quarantine folder within an email account at the recipient address; and
further comprising:
loading the email into an administrator folder;
within an administrator email viewer, in response to selection of the email from the administrator folder:
rendering the email with the first sequence of words highlighted in the first color according to the first visual highlighting scheme and with the second sequence of words highlighted in the second color; according to the second visual highlighting scheme;
labeling the first color as corresponding to the financial signal; and
labeling the second color as corresponding to the action request signal; and
in response to manual identification of the email as malicious within the administrator email viewer prior to review of the email in the quarantine folder, discarding the email from the quarantine folder within the email account at the recipient address.

6. The method of claim 1:
wherein redirecting the email to the quarantine folder comprises redirecting the email from an email inbox to the quarantine folder within an email account at the recipient address; and
further comprising:
loading the email into an administrator folder;
within an administrator email viewer, in response to selection of the email from the administrator folder:
rendering the email with the first sequence of words highlighted in the first color according to the first visual highlighting scheme and with the second sequence of words highlighted in the second color; according to the second visual highlighting scheme
labeling the first color as corresponding to the financial signal; and
labeling the second color as corresponding to the action request signal; and
in response to manual identification of the email as benign within the administrator email viewer prior to review of the email in the quarantine folder, transferring the email from the quarantine folder to the email inbox within the email account at the recipient address.

7. The method of claim 1:
further comprising:
scanning the email for attachments;
in response to detecting an attachment in the email:
extracting a set of characters from the attachment; and
scanning the set of characters for the set of language signals;
correlating a third sequence of words, in the attachment, with a third signal in the set of language signals; and
wherein calculating the risk for the email comprises calculating the risk for the email based on the combination of:
the financial signal and the action request signal detected in the email; and
the third signal detected in the set of characters extracted from the attachment.

8. The method of claim 1:
further comprising:
intercepting a second email inbound to the recipient address from a sender at a second time;
scanning a second body of the second email for the set of language signals;
correlating a third sequence of words, in the second email, with a third signal in the set of language signals;
correlating a fourth sequence of words, in the second email, with a fourth signal in the set of language signals;
calculating a second risk for the second email representing a second financial attack based on a second combination of the third signal and the fourth signal detected in the second email; and
in response to the second risk falling below the threshold risk, releasing the second email to an email inbox within an email account at the recipient address;
wherein accessing the email comprises intercepting the email inbound to the recipient address from the sender at a first time succeeding the second time;
further comprising identifying the first email and the second email as forming an email thread;
wherein calculating the risk for the email comprises, in response to identifying the first email and the second email as forming the email thread, calculating the risk for the email thread based on the combination of:
the financial signal and the action request signal detected in the email; and
the third signal detected in the second email; and
further comprising, in response to the risk exceeding the threshold risk, transferring the second email from the email inbox to the quarantine folder within the email account at the recipient address.

9. The method of claim 1:
wherein correlating the first sequence of words, in the email, with the financial signal comprises:
accessing a first natural language processing model trained on a financial services and financial transaction lexicon;
based on the first natural language processing model, identifying the first sequence of words, related to financial transactions, in the email;
normalizing the first sequence of words to a first standard financial transaction language concept; and
representing the first standard financial transaction language concept in the financial signal;
further comprising:
based on the first natural language processing model, identifying a third sequence of words, related to financial transactions, in the email;
normalizing the third sequence of words to a second standard financial transaction language concept; and
representing the second standard financial transaction language concept in a second financial signal;
wherein correlating the second sequence of words, in the email, with the action request signal comprises:
accessing a second natural language processing model trained on an action request and prompt lexicon;
based on the second natural language processing model, identifying the second sequence of words, describing an action request, in the email;
normalizing the second sequence of words to a standard action request language concept; and
representing the standard action request language concept in the action request signal;
further comprising annotating the third sequence of words in the email according to the first visual highlighting scheme; and
wherein calculating the risk for the email comprises calculating the risk for the email based on the combination of the financial signal, the second financial signal, and the action request signal detected in the email.

10. The method of claim 1:
wherein correlating the first sequence of words, in the email, with the financial signal comprises:
accessing a first natural language processing model trained on a financial services and financial transaction lexicon;
based on the first natural language processing model, identifying the first sequence of words, related to financial transactions, in the email;
normalizing the first sequence of words to a first standard financial transaction language concept; and
representing the first standard financial transaction language concept in the financial signal;
wherein correlating the second sequence of words, in the email, with the action request signal comprises:
accessing a second natural language processing model trained on an action request and prompt lexicon;
based on the second natural language processing model, identifying the second sequence of words, describing an action request, in the email;
normalizing the second sequence of words to a standard action request language concept; and
representing the standard action request language concept in the action request signal;
further comprising:
accessing a third natural language processing model trained on a sensitive data lexicon;
based on the third natural language processing model, identifying a third sequence of words, describing sensitive personal information, in the email;
normalizing the third sequence of words to a standard sensitive data language concept;
representing the standard sensitive data language concept in a sensitive data signal; and
annotating the third sequence of words in the email according to a third visual highlighting scheme associated with the sensitive data signal, the third visual highlighting scheme different from the first visual highlighting scheme and the second visual highlighting scheme; and
wherein calculating the risk for the email comprises calculating the risk for the email based on the combination of the financial signal, the action request signal, and the sensitive data signal detected in the email.

1. method of claim 1:
wherein correlating the first sequence of words, in the email, with the financial signal comprises:
accessing a first natural language processing model trained on a financial services and financial transaction lexicon;
based on the first natural language processing model, identifying the first sequence of words, related to financial transactions, in the email;
normalizing the first sequence of words to a first standard financial transaction language concept; and
representing the first standard financial transaction language concept in the financial signal;
wherein correlating the second sequence of words, in the email, with the action request signal comprises:
accessing a second natural language processing model trained on an action request and prompt lexicon;
based on the second natural language processing model, identifying the second sequence of words, describing an action request, in the email;
normalizing the second sequence of words to a standard action request language concept; and
representing the standard action request language concept in the action request signal;
further comprising:
accessing a third natural language processing model trained on an urgency and deadline lexicon;
based on the third natural language processing model, identifying a third sequence of words, describing urgency of the standard action request, in the email;
normalizing the third sequence of words to a standard urgency language concept;
representing the standard urgency language concept in an urgency data signal; and
annotating the third sequence of words in the email according to a third visual highlighting scheme associated with the urgency signal, the third visual highlighting scheme different from the first visual highlighting scheme and the second visual highlighting scheme; and
wherein calculating the risk for the email comprises calculating the risk for the email based on the combination of the financial signal, the action request signal, and the urgency signal detected in the email.

12. The method of claim 11, wherein calculating the risk for the email comprises:
aggregating the financial signal, the action request signal, and the urgency signal into a target vector;
accessing a corpus of stored vectors representing and labeled with known email-based attack types;
identifying a particular vector, in the corpus of stored vectors, nearest the target vector in a multi-dimensional feature space;
characterizing a distance between the particular vector and the target vector in the multi-dimensional feature space; and
calculating the risk for the email inversely proportional to the distance.

13. The method of claim 12:
wherein accessing the email comprises intercepting the email inbound to the recipient address within an email domain; and
further comprising:
retrieving an attribute of a recipient associated with the recipient address;
accessing a corpus of risk profiles, each risk profile in the corpus of risk profiles:
associated with a set of attributes; and
specifying risk thresholds for a set of known email-based attack types based on the set of attributes;
associating the recipient address with a particular risk profile, in the corpus of risk profiles, based on the attribute; and
reading the risk threshold from the particular risk profile based on a particular email-based attack type represented by the particular vector.

14. The method of claim 1:
wherein correlating the first sequence of words, in the email, with the financial signal comprises:
accessing a first natural language processing model trained on a financial services and financial transaction lexicon;
based on the first natural language processing model, identifying the first sequence of words, related to financial transactions, in the email;
normalizing the first sequence of words to a first standard financial transaction language concept; and
representing the first standard financial transaction language concept in the financial signal;
wherein correlating the second sequence of words, in the email, with the action request signal comprises:
accessing a second natural language processing model trained on an action request and prompt lexicon;
based on the second natural language processing model, identifying the second sequence of words, describing an action request, in the email;
normalizing the second sequence of words to a standard action request language concept; and
representing the standard action request language concept in the action request signal;
further comprising:
extracting a sender address from the email;
querying a historical email database for a frequency of historical email communications between the sender address and the recipient addresses; and
representing the frequency of historical email communications in a historical communication signal; and
wherein calculating the risk for the email comprises calculating the risk for the email based on the combination of:
the financial signal and the action request signal detected in the email; and
the historical communication signal.

15. The method of claim 1:
further comprising accessing a database of attack templates, each attack template in the database of attack templates:
representing a known attack type;
labeled with a risk score; and
specify a set of signals indicative of an email-based attack of the known attack type; and
wherein calculating the risk for the email comprises:
matching the financial signal and the action request signal detected in the email to a set of set of signals specified in a particular attack template in the database of attack templates;
reading a particular risk score from the particular attack template; and
calculating the risk for the email based on the particular risk score.

1. method of claim 1:
wherein accessing the email comprises intercepting the email inbound to the recipient address within an email domain;
further comprising:
accessing a corpus of past emails inbound to recipients within the email domain, the corpus of past emails comprising a first subset of past emails labeled as malicious and a second subset of past emails labeled as benign;
detecting financial signals and action request signals in the corpus of past emails; and
training a risk model based on the first subset of past emails labeled as malicious, the second subset of past emails labeled as benign, and financial signals and action request signals detected in emails in the corpus of past emails, the risk model configured to return a risk score based on financial signals and action request signals detected in an inbound email; and
wherein calculating the risk for the email comprises inserting the financial signal and the action request signal, extracted from the email, into the risk model to calculate the risk for the email.

17. The method of claim 16, wherein training the risk model comprises:
initializing the risk model based on the first subset of past emails labeled as malicious, the second subset of past emails labeled as benign, and financial signals and action request signals detected in the corpus of past emails;
selecting a third subset of past emails, in the corpus of past emails, excluding malicious and benign labels;
for each past email in the third subset of past emails:
scanning a past body of the past email for language signals; and
inserting language signals, extracted from the past email, into the risk model to calculate a past risk for the past email;
identifying a fourth subset of past emails, from the third subset of past emails, associated with past risks exceeding the threshold risk;
for each past email in the fourth subset of past emails:
generating a prompt to investigate the past email;
serving the prompt to an administrator; and
labeling the past email according to a response supplied by the administrator; and
retraining the risk model based on the first subset of past emails, the second subset of past emails, the fourth subset of past emails, and financial signals and action request signals detected in emails in the corpus of past emails.

18. A method for detecting financial attacks in emails comprising:
intercepting an email inbound to a recipient address;
scanning a body of the email for a set of language signals;
correlating a first sequence of words, in the email, with a financial signal in the set of language signals;
correlating a second sequence of words, in the email, with an action request signal in the set of language signals;
correlating a third sequence of words, in the email, with an urgency signal in the set of language signals;
calculating a risk for the email representing a financial attack based on a combination of the financial signal, the action request signal, and the urgency signal detected in the email; and
in response to the risk exceeding a threshold risk:
annotating the first sequence of words in the email according to a first visual highlighting scheme associated with the financial signal;
annotating the second sequence of words in the email according to a second visual highlighting scheme associated with the action request signal, the second visual highlighting scheme different from the first visual highlighting scheme;
annotating the third sequence of words in the email according to a third visual highlighting scheme associated with the urgency signal, the third visual highlighting scheme different from the first visual highlighting scheme and the second visual highlighting scheme; and
redirecting the email away from an email inbox associated with the recipient address.

19. A method for detecting financial attacks in emails comprising:
intercepting an email inbound to a recipient address;
scanning a body of the email for a set of language signals;
correlating a first sequence of words, in the email, with a first signal in the set of language signals;
correlating a second sequence of words, in the email, with a second signal in the set of language signals;
calculating a risk for the email representing a financial attack based on a combination of the first signal and the second signal detected in the email;
in response to the risk exceeding a threshold risk:
annotating the first sequence of words in the email according to a first visual highlighting scheme associated with the financial signal;
annotating the second sequence of words in the email according to a second visual highlighting scheme associated with the action request signal, the second visual highlighting scheme different from the first visual highlighting scheme; and
redirecting the email away from an email inbox associated with the recipient address; and
in response to selection of the email within an email viewer, rendering the email with the first sequence of words highlighted according to the first visual highlighting scheme and with the second sequence of words highlighted according to the second visual highlighting scheme.

20. The method of claim 19:
wherein intercepting the email comprises intercepting the email inbound to the recipient address within an email domain; and
further comprising:
retrieving an attribute of a recipient associated with the recipient address;
accessing a risk schedule specifying a set of threshold risks, each threshold risk in the set of threshold risks associated with a unique combination of recipient attributes and based on malicious targeting frequency of recipients represented by the unique combination of recipient attributes within the email domain; and
selecting the threshold risk, from the risk schedule, based on the attribute of the recipient.
